(19) United States
(12) Patent Application Publication
(10) Pub. No.: US 2010/0005731 A1
(43) Pub. Date: Jan. 14, 2010

(54) Tower and wind turbine supporting structures and method for mounting the latter

(76) Inventors: Russel H. Marvin, Goshen, CT (US); Bert Thomas Sleicher, Naugatuck, CT (US)

Correspondence Address: TED PAULDING, 10 PENWOOD LA, WETHERSFIELD, CT, 06109, US

(21) Appl. No.: 12/217,916

(22) Filed: Jul. 9, 2008

(51) Int. Cl. E04H 12/00; F03D 11/04; B23P 11/00; E04H 12/34

(52) U.S. Cl. 52/40; 416/244 R; 29/889; 52/651.01

(57) ABSTRACT

A tower and wind turbine supporting structure which at least partially envelops the tower. The tower is of uniform cross sectional configuration throughout and has a plurality of outriggers. The outriggers are connected with the tower after the wind turbines and their supporting structure have been positioned at the base of the tower, raised to their point of attachment and secured in place. Individual foundation members for each vertical tower member and for each outrigger are in the form of micro piles. Another aspect of the method of the invention involves providing a tower of uniform cross section, positioning wind turbines and their supporting structures sequentially at the base of the tower, raising them and mounting them on the tower sequentially, and thereafter providing a plurality of outriggers and their foundations and attaching them to the tower.

### RELATED APPLICATIONS

U.S. patent application Ser. No. 12/006,024 entitled IMPROVED INLET PASSAGEWAY AND SEALING IN A TURBINE WIND POWER GENERATING SYSTEM filed Dec. 28, 2007, invented by Russel H. Marvin, hereby incorporated herein by reference, and

U.S. patent application Ser. No. 12/077,556 entitled ACCELERATOR FOR USE IN A WIND POWER ELECTRICAL GENERATING SYSTEM, filed Mar. 28, 2008 invented by Russel H. Marvin, also incorporated herein by reference.

### BACKGROUND OF THE INVENTION

The construction of wind turbines and associated apparatus on supporting towers at elevations reaching hundreds of feet is a difficult, dangerous and very expensive proposition. Further, the massive foundations required for the exceptionally high towers are also a major component of the overall cost of wind turbine generation of electrical power.

Accordingly, it is a general object of the present invention to provide a tower and wind turbine supporting structure configuration and a method of mounting wind turbines and their supporting structures on the tower which dramatically reduces the overall cost of construction of a wind turbine electrical generating system.

A further object of the invention resides in the provision of an improved foundation system which can be installed employing a relatively simple process involving a minimum number of steps at substantial economic advantage and which is yet highly efficient and durable in operation.

### SUMMARY OF THE INVENTION

In accordance with the present invention and in fulfillment of the foregoing object a tower is provided for mounting wind turbines and their supporting structures which at least partially envelop the tower at elevated positions for enhanced wind velocities. The tower comprises a plurality of horizontally spaced apart vertically extending narrow elongated and lightweight members and a plurality of shorter narrow lightweight interconnecting cross members extending between the vertical members and cooperating therewith to form a massive monolithic structure having a vertical dimension of at least thirty (30) feet. In the illustrative embodiment of the invention shown and described herein below a tower of two hundred (200) feet in height is provided and the exterior cross sectional configuration and dimensions of the tower from its base to the area of attachment of the wind turbine supporting structures is substantially uniform. At the top of the tower a power operated lifting device is provided and has at least one (1) depending lift line, two (2) shown. Adjacent the base of the tower a plurality of diagonally extending outriggers are provided for attachment to the tower after the turbines and their supporting structures have been positioned adjacent the tower at its base, raised by said power lifting device, and then secured in place at their respective operating positions.

The outriggers are spaced apart horizontally about the tower and each is of narrow elongated and lightweight but rigid construction providing support against both tension and compression loading. Each outrigger has its upper end portion connected to the tower in supporting relationship therewith and its lower end portion is disposed in horizontally spaced relationship with the tower at least approximately at ground level.

Finally, a foundation system is provided and supports each vertical member of the tower and each outrigger individually at its lower end portion. More particularly, the foundation preferably comprises a discrete member for each tower and outrigger member supported thereby, each foundation member being of narrow elongated configuration and of composite metallic and concrete construction. The foundation members extend downwardly from their supported members into the earth a substantial distance and provide effective resistance against both compression and tension forces, micro piles being presently preferred.

In another embodiment of the invention, the vertical members of the tower and the outriggers may be supported by micro piles extending from their supported members to anchors in bed rock which is reasonably close to the surface.

Preferably, the wind turbine and support structures carry a pair of turbines on opposite sides of the support structure with a pair of wind accelerating surfaces or passageways respectively capturing and accelerating a flow of wind to the turbines. A wide variety of wind turbine and supporting structures may be employed but the turbine and support structure or “accelerator” design of the aforementioned patents is presently preferred. In this embodiment the supporting structure completely surrounds the tower and the tower is of substantially uniform cross section throughout its height. In other embodiments of the invention when the tower may for example have a rectangular cross section with wind turbine supporting structures of generally U shaped or parti-circular cross section, the relationship between the tower and the supporting structures is established such that the tower exterior dimensions are uniformly less than those of the supporting structures at least in the areas where they reside in adjacent relationship during raising and assembly. Thus, for example the fourth exposed side of a rectangular tower may take a completely irregular configuration.

In accordance with the method of the invention a tower of the desired height and substantially uniform cross section from its base to the desired area of attachment of the wind turbines and their supporting structures is first constructed. At least one wind turbine and its supporting structure is then positioned on the ground adjacent the base of the tower. The wind turbine and support structure is thereafter raised without the need for a large crane to its desired point of attachment and secured in place. At least three diagonal outriggers and their respective foundations are then provided and the upper end portions of the outriggers are connected to the tower in spaced relationship thereabout, the lower end portions of the outriggers being attached to their respective foundations.

When each wind turbine and supporting structure comprises a pair of turbines are arranged on opposite sides thereof and spaced between 150 and 210 degrees and are approximately one hundred and seventy (170) degrees apart in the presently preferred embodiment of the invention. Each supporting structure at least partially envelopes the tower and provides at least one surface to capture the wind and accelerate flow to the turbines. Further, when a plurality of wind turbines and supporting structures are provided, the wind turbines and supporting structures are disposed sequentially adjacent the base of the tower, raised sequentially to their desired positions and attached proceeding from the uppermost wind turbine and supporting structure downwardly to the lowermost.

As will be apparent, the method of the invention accommodates the construction of the wind turbines and their supporting structures on the ground and thus avoids the excessive labor and/or crane costs encountered with construction at high elevations.

Optionally, the wind turbines and supporting structures may be manufactured completely on site or manufactured in sections off-site, transported to the site and thereafter assembled sequentially adjacent the tower base.

### DESCRIPTION OF THE DRAWINGS

FIG. 1 is a somewhat schematic elevation showing a tower without outriggers during practice of the method of the invention, a wind turbine and its supporting structure being shown at the base of the tower and a power lifting device at the top of the tower.

FIG. 2 is a view in elevation similar to FIG. 1 but showing the tower, wind turbines and supporting structures mounted thereon, outriggers in place about the base of the tower with foundation members supporting the tower and outriggers, and

FIG. 3 is a fragmentary view in elevation showing a lower portion of the tower and outriggers in greater detail.

### DESCRIPTION OF PREFERRED EMBODIMENT

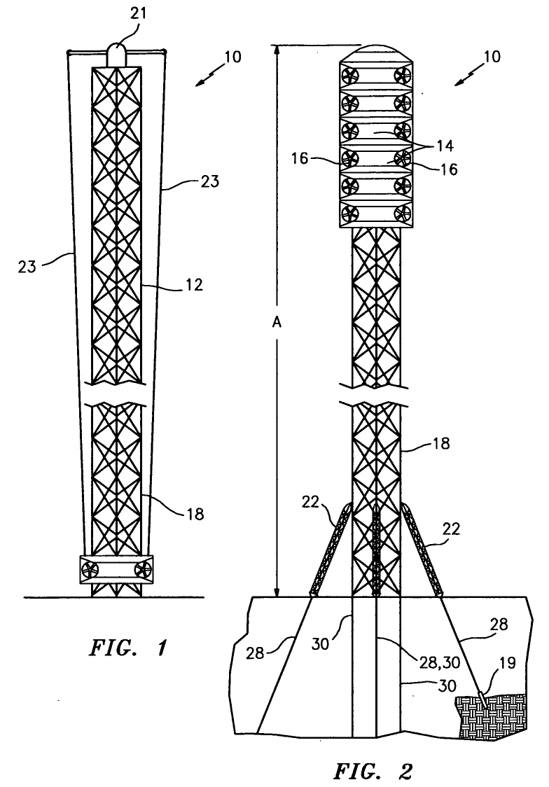

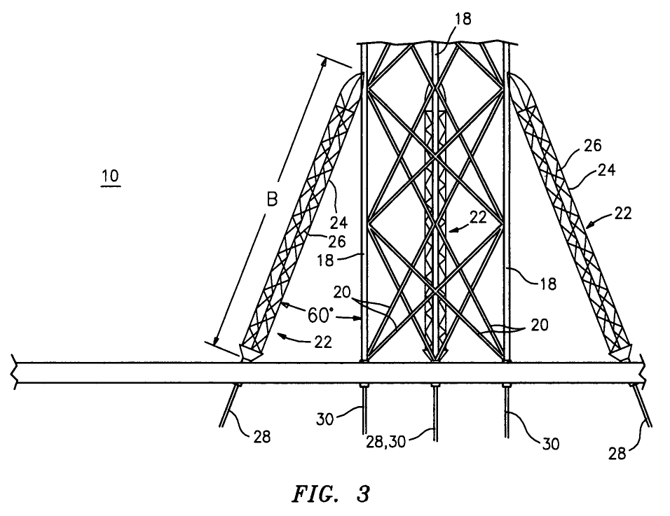

Referring in particular to FIGS. 1 and 2, a tower for mounting wind turbines and their supporting structures is indicated generally at 10 with the tower proper at 12, supporting structures at 14,14 and turbines at 16,16. The illustrative tower 12 shown has a height A of two hundred (200) feet. As best illustrated in FIG. 3, the tower 12 includes a plurality of narrow elongated and lightweight vertically extending longitudinal members 18,18, preferably tubular, and a plurality of shorter narrow lightweight interconnecting cross members 20,20. The cross members 20,20 may be tubular or triangular in cross section in a truss structure. The members 20,20 extend between the members 18,18 and cooperate therewith to form a massive monolithic structure having a vertical dimension of at least fifty (50) feet. The cross section and other structural characteristics of the tower may vary but in all cases the cross sectional dimensions and configuration of the tower from its base to the area of connection with the wind turbine supporting structures must be at least partially uniform to permit raising of the wind turbines and their supporting structures thereabout. Tower 12 is of a presently preferred triangular vertically uniform cross sectional configuration the short cross members 20,20 extending diagonally between the vertical members 18,18.

Mounted at or near the top of the tower is a power operated lifting device 21 which is shown with a pair of depending lift lines 23,23 respectively on opposite sides of the tower 12 and connected with a wind turbine supporting structure 14 at the base of the tower.

The wind turbines 16,16 and their supporting structures 14,14 may vary widely in construction but as mentioned above are preferably of the type disclosed in the aforementioned patents and completely surround the tower 12. It should also be noted that the supporting structures are mounted for incremental rotation about the tower in adjusting the position of the turbines for optimum performance in response to change in the direction of wind flow.

As best illustrated in FIG. 3, a plurality of longitudinally rigid outriggers are provided for support in both tension and compression. As shown, three (3) outriggers 22,22 are provided and each outrigger 22 is of tubular metallic construction with three (3) longitudinally extending elongated members 24,24 in a triangular configuration and a plurality of shorter tubular members 26,26 interconnecting the longitudinal members. The outriggers 22,22 have their upper end portions connected in supporting relationship with the vertical longitudinally members of the tower; three (3) outriggers being provided for the triangular tower 12. Preferably, the connection of the outriggers with the tower is effected at the point where at least one cross member 20 connects with a vertical member 18. The outriggers have a length B in the range twenty (20) to one hundred (100) feet and, in the illustrative embodiment shown, the outriggers have a length B of approximately fifty (50) feet. The outriggers are at an angle with the vertical in the range of thirty (30) to eighty (80) degrees, the preferred angle being approximately sixty (60) degrees.

At lower end portions the outriggers 22,22 are preferably provided with separate foundation members in the form of elongated members 28,28 of composite metallic and concrete construction. As shown, the foundation members 28,28 take the form of micro piles of the type sold and installed by CON-TECHK SYSTEMS LTD. of 8150 River Road, Delta, B.C. Canada V4G 1B5 under the trademarks SCHEBECK and TITAN and extend downwardly into the earth at angles substantially the same as that of the members which they support. The length of the micro pile members should be in the range of twenty (20) to fifty (50) feet and in the illustrative embodiment shown, the outrigger foundation members 28.28 are approximately thirty (30) feet long.

When bedrock is reasonably close to the surface, the foundation members 28,28 may be supported by anchors 19 embedded in the bedrock, one shown on the right hand member 28 in FIG. 2.

Foundation members 30,30 for the vertical members 18,18 of the tower 12 are preferably the same as those for the outriggers with the length of the members falling in the range of twenty (20) to fifty (50) feet. In the illustrative embodiment shown the length of the members 30,30 is approximately thirty (30) feet and the members extend vertically, downwardly from the vertical members which they support.

In accordance with the method of the invention, and as mentioned above, a tower at least partially uniform in cross section is provided and the wind turbines and their supporting structures are positioned at the base of the tower, raised to the area of attachment, and secured in place. When twin turbines are provided, the supporting structures at least partially envelope the base of the tower and may be manufactured off-site in sections and assembled around the tower base, or they may be manufactured onsite about the tower base. Thereafter, when all of the wind turbine and supporting structures have been raised and secured in place, the outriggers may be assembled with the tower and their foundations to complete the installation.

As will be apparent from the forgoing, an improved tower and foundation design has been provided with substantial savings achieved particularly in the foundation system.

The method of the invention also provides for substantial savings in avoidance of the excessive cost of labor and large cranes for assembly or repair of the wind turbines and supporting structures at high elevations.

1. A tower and wind turbine supporting structure which at least partially envelops the tower at an elevated position for enhanced wind velocity; the tower comprising a plurality of horizontally spaced apart vertically extending narrow elongated and lightweight members and a plurality of shorter narrow lightweight interconnecting cross members extending between the vertical members and cooperating therewith to form a massive monolithic structure having a vertical dimension of at least thirty five (35) feet, the exterior cross sectional configuration and dimensions of the tower from its base to the area of attachment of the wind turbine supporting structure being less than that of the adjacent interior cross sectional surfaces of the wind turbine supporting structure, at least one power operated lifting device mounted substantially at the top of the tower and having at least one lift line extending downwardly therefrom, a plurality of diagonally extending outriggers adapted to be attached to the tower after the turbine and supporting structure has been positioned at the base of the tower, raised to its respective operating position by said lifting device and secured in place, the outriggers being spaced apart horizontally about the base of the tower and each being of narrow elongated and lightweight but longitudinally rigid construction, each outrigger having its upper end portion connected to the tower in supporting relationship therewith and its lower end portion disposed in horizontally spaced relationship with the tower at least approximately at ground level, and a foundation system supporting each vertical structural member of the tower and each outrigger at its lower end portion.

2. A tower and wind turbine supporting structure as set forth in claim 1 wherein the cross section of the tower is substantially uniform from its base to the point of attachment of the wind turbine supporting structure.

3. A tower and wind turbine supporting structure as set forth in claim 1 wherein the supporting structure completely surrounds the tower and all exterior cross sectional dimensions of the tower are less than those of the interior dimensions of the supporting structure.

4. A tower and wind turbine supporting structure as set forth in claim 1 wherein the tower is adapted to mount turbine support structures which have at least one wind directing surface leading to a pair of wind turbines on opposite sides of the support structure.

5. A tower and wind turbine supporting structure as set forth in claim 1 wherein the tower has a triangular cross sectional configuration, and wherein the vertical members thereof are tubular in cross section.

6. A tower and wind turbine supporting structure as set forth in claim 1 wherein the outriggers have a triangular cross sectional configuration.

7. A tower and wind turbine supporting structure as set forth in claim 6 wherein each outrigger is constructed of tubular metallic structural members with three (3) longitudinally extending elongated tubular members in a spaced apart triangular configuration and a plurality of short tubular cross members interconnecting the longitudinal members.

8. A tower and wind turbine supporting structure as set forth in claim 1 wherein the outriggers have their upper end portions connected with the tower at substantially the same height as the attachment of at least one of the tower cross members to a vertical longitudinal tower member.

9. A tower and wind turbine supporting structure as set forth in claim 1 wherein the vertical longitudinal members of the tower and the outriggers are each supported individually at lower end portions by discrete foundation members.

10. A tower and wind turbine supporting structure as set forth in claim 9 wherein each of the foundation members is a narrow elongated member of composite metallic and concrete construction, each foundation member having its upper end portion connected in supporting relationship with its supported member and extending downwardly into the earth a substantial distance therefrom.

11. A tower and wind turbine supporting structure as set forth in claim 10 wherein each foundation member is a micro pile.

12. A tower and wind turbine and their supporting structures as set forth in claim 10 wherein each foundation member extends downwardly into the earth at substantially the same angle as the member supported thereby.

13. A tower and wind turbine supporting structure as set forth in claim 1 wherein the tower is approximately two hundred (200) feet in height, the outriggers are approximately fifty (50) feet in length, and the angle between the outriggers and the vertical is between forty (40) and eighty (80) degrees.

14. A tower and wind turbine supporting structure as set forth in claim 13 wherein the angle between the outriggers and the vertical is approximately sixty (60) degrees.

15. A tower and wind turbine supporting structure as set forth in claim 1 wherein at least one of the foundation members for the vertical members of the tower and the outriggers is supported on bed rock.

16. A method for mounting wind turbines and supporting structures which at least partially envelop a tower at elevated positions on the tower for enhanced wind velocities, said method comprising the steps of constructing a tower of the desired height and of cross sectional dimensions from its base to the desired point of attachment which are less than those of the adjacent interior surfaces of the wind turbine supporting structures, positioning a wind turbine and supporting structure adjacent the base of the tower, raising the wind turbine and supporting structure to its desired elevation and mounting the same on the tower, providing at least three diagonal outriggers and foundations therefore, attaching upper end portions of the outriggers to the tower in spaced relationship thereabout, and attaching the lower end portions of the outriggers to their respective foundations.

17. A method as set forth in claim 16 wherein a plurality of wind turbines and supporting structures are provided, and wherein the wind turbines and supporting structures are disposed sequentially at the base of the tower and raised to their mounting positions sequentially proceeding from the uppermost wind turbine and supporting structure downwardly to the lowermost.

18. A method as set forth in claim 16 wherein each wind turbine and supporting structure comprises a pair of turbines spaced approximately one hundred fifty (150) to two hundred ten (210) degrees apart, and wherein each supporting structure at least partially envelopes the tower and provides at least one wind flow directing surface accelerating flow to the turbines.

19. A method as set forth in claim 17 wherein the wind turbines and supporting structures are manufactured off-site and transported to the base of the tower.

20. A method as set forth in claim 16 wherein the wind turbines and their supporting structures are substantially completely manufactured on site about the base of the tower.

21. A method as set forth in claim 16 wherein the wind turbines and their supporting structures are manufactured off-site in sections, and wherein the sections are transported to the site and assembled sequentially about the tower base and thereafter raised and secured in position.

22. A method as set forth in claim 21 wherein the sections are no larger than that allowed for truck transport.

23. A method as set forth in claim 16 wherein a power-lifting device is provided at the top of the tower for raising the wind turbine and supporting structure

24. A tower for mounting wind turbine supporting structure which at least partially envelops the tower at an elevated position for enhanced wind velocity; the tower comprising a plurality of horizontally spaced apart vertically extending narrow elongated and lightweight members and a plurality of shorter narrow lightweight interconnecting cross members extending between the vertical members and cooperating therewith to form a massive monolithic structure having a vertical dimension of at least thirty five (35) feet, the exterior cross sectional configuration and dimensions of the tower from its base to the area of attachment of the wind turbine supporting structure being less than that of the adjacent interior cross sectional surfaces of the wind turbine supporting structure, at least one power operated lifting device mounted substantially at the top of the tower and having at least one lift line extending downwardly therefrom, a plurality of diagonally extending outriggers adapted to be attached to the tower after the turbine and supporting structure has been positioned at the base of the tower, raised to its respective operating position by said lifting device and secured in place, the outriggers being spaced apart horizontally about the base of the tower and each being of narrow elongated and lightweight but longitudinally rigid construction, each outrigger having its upper end portion connected to the tower in supporting relationship therewith and its lower end portion disposed in horizontally spaced relationship with the tower at least approximately at ground level, and a foundation system supporting each vertical structural member of the tower and each outrigger at its lower end portion.
